(19) United States
(12) Patent Application Publication
(10) Pub. No.: US 2011/0235859 A1
(43) Pub. Date: Sep. 29, 2011

(54) Signal processor

(75) Inventor: Kazunori Imoto, Kanagawa-ken (JP)

(73) Assignee: KABUSHIKI KAISHA TOSHIBA, Tokyo (JP)

(21) Appl. No.: 12/923,278

(22) Filed: Sep. 13, 2010

(30) Foreign Application Priority Data
Mar. 26, 2010 (JP) P2010-073701

(51) Int. Cl. G06K 9/00

(52) U.S. Cl. 382/103

(57) ABSTRACT

A signal processor includes an input unit, an extraction unit, a calculation unit, a determination unit, and an output unit. The input unit receives a moving image including a plurality of images. The extraction unit analyzes the moving image and extracts a representative image from the moving image. The calculation unit calculates a change amount of a partial moving image including the representative image. The change amount indicates degree of change. The determination unit uses the change amount to judge which the representative image or at least a part of the moving image is outputted. The output unit outputs the representative image or the partial moving image according to a corresponding output format.

### CROSS-REFERENCE TO RELATED APPLICATION

This application is based upon and claims the benefit of priority from Japanese Patent Application No. 2010-073701, filed on Mar. 26, 2010, the entire contents of which are incorporated herein by reference.

### FIELD

Embodiments described herein relate generally to a signal processor for processing images.

### BACKGROUND

When a high-quality moving image and a high-quality still image are photographed, it takes time to manually switch photographing mode between still image photographing mode and moving image photographing mode. Since photographing situations change from moment to moment, an important photographing opportunity might be lost.

A method to manage automatically is disclosed in JP-A 2009-38649 (KOKAI). In this reference, both a still image and moving images before and after the still image are photographed and buffered once. Then, it is automatically determined which the still image and the moving images is recorded, depending on a photographed subject. Moreover, the method uses a change amount of an image based on an amount of coding in order to switch between a moving image and a still image. However, an image having a small change amount will be recorded as a still image, even if the image is actually better to be recorded as a moving image. In addition, a user gives a trigger to photograph the still image and the moving image. Accordingly, the recording of a material worth being viewed depends on the operation by the user. Thus, the method cannot be applied to a moving image material which is continuous for a long time with no record of the user's operation, and therefore the user still performs selecting the material.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram illustrating a hardware configuration of a signal processor according to a first embodiment;

FIG. 2 is a block diagram showing functional elements in the signal processor;

FIG. 3 shows an example of the analysis result outputted from the analysis unit;

FIG. 4 is a flow chart explaining operation of the extraction unit;

FIG. 5 is a flow chart explaining operation of the calculation unit;

FIG. 6 is a block diagram showing functional elements in the signal processor according to a second embodiment;

FIG. 7 shows an example of the analysis result outputted from the analysis unit;

FIG. 8 is a flow chart explaining operation of the calculation unit;

FIG. 9 is a block diagram showing functional elements in the signal processor according to a third embodiment;

FIG. 10 shows an example of the analysis result outputted from the analysis unit; and

FIG. 11 is a flow chart explaining operation of the calculation unit.

### DETAILED DESCRIPTION

According to one aspect of the invention, a signal processor includes an input unit to receive a moving image including a plurality of images, an extraction unit to analyze the moving image and to extract a representative image from the moving image, a calculation unit to calculate a change amount of a partial moving image including the representative image, a determination unit, using the change amount, to judge which the representative image or at least a part of the moving image is outputted, and an output unit to output the representative image or the partial moving image according to a corresponding output format.

Digital video cameras are mainly used to photograph moving images. On the other hand, digital still cameras are mainly used to photograph still images. Recently, the digital video cameras have become capable of photographing high-quality still images as same as the digital still cameras. Similarly, the digital still cameras have become capable of photographing high-quality moving images. Furthermore, switching between the still image photographing and the moving image photographing has become possible according to a subject to be photographed. There have also been widely used software and services to generate a slide show and a summarized moving image in which music and effects are added to multiple still images (a group of still images) or multiple groups of moving image clips (a portion of the photographed moving image) photographed by an user. Accordingly, contents possessed by the user may be able to be easily shared.

However, even if high-quality moving images or still images can be photographed, it is the user to select materials to be used for a slide show or a summarized moving image. Easy sharing of personal contents has not been achieved, so that the labor of the user is not reduced. When a summarized moving image including moving images and still images which are effectively mixed is generated by using only a long-time continuous moving image as a material of the summarized moving image, the generation requires an operation of determining whether still images are to be outputted and recorded from the moving image, or moving images are to be outputted and recorded. Actually, the user might not easily find a position of an important scene to be used for the summarized moving image. According to the embodiments, descriptions are given of devices capable of automatically generating a summarized moving image with moving images and still images mixed, even from only moving image materials. The devices are capable of assisting the user in easily generating a summarized moving image to be displayed on a personal computer or a television, for example.

Hereinafter, the embodiments will be explained with reference to the accompanying drawings.

### Description of the First Embodiment

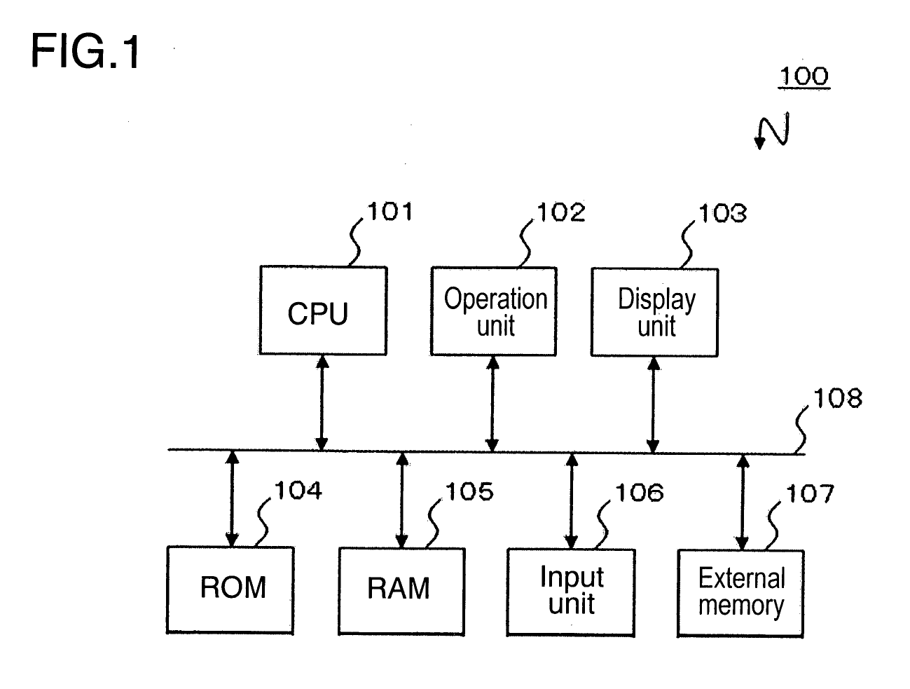

Firstly, a hardware configuration of a signal processor according to a first embodiment will be described with reference to FIG. 1. A signal processor 100 includes a controller 101 that controls the whole device, such as a central processing unit (CPU), memories that store various kinds of data and various kinds of programs, such as a read only memory (ROM) 104 and a random access memory (RAM) 105, an input unit 106 that inputs a signal, such as an image or a sound, an external memory 107 that stores various kinds of data and various kinds of programs, such as a hard disk drive (HDD) or a compact disk (CD) drive device, and a bus 108 that connects the units to one another. The signal processor 100 has the hardware configuration using an ordinary computer. Furthermore, the signal processor 100 is connected to a display unit 103 that displays images or the like, an operation unit 102 that receives an instruction input by a user, such as a key board or a mouse, and a communication interface (I/F) that controls communication with an external device in a wired or wireless medium to one another.

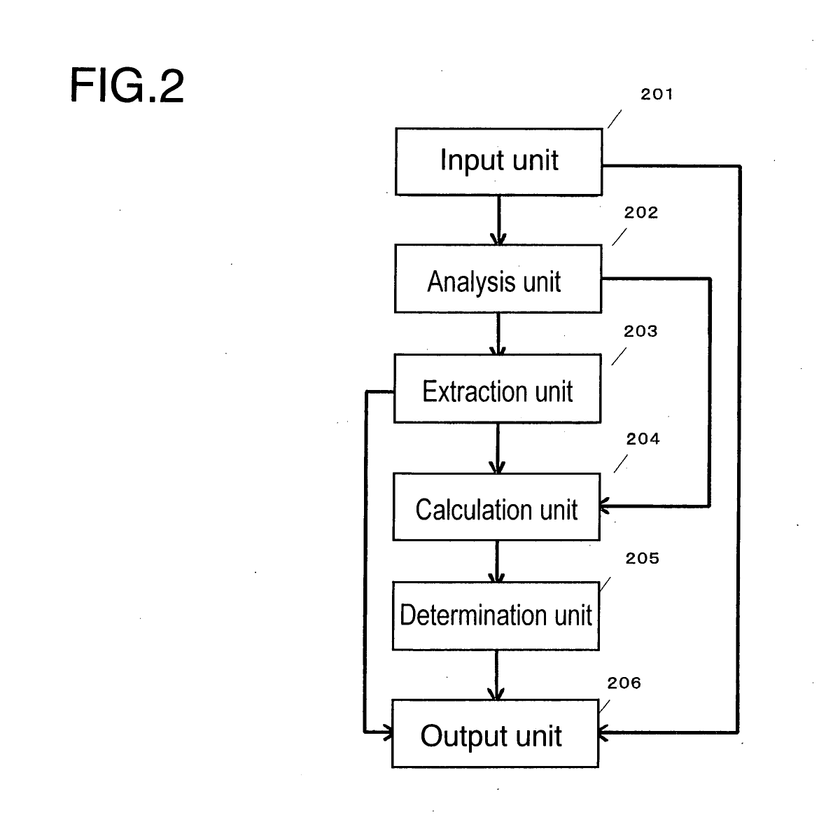

FIG. 2 is a block diagram showing functional elements in the signal processor 100. The signal processor 100 includes an input unit 201, an analysis unit 202, an extraction unit 203, a calculation unit 204, a determination unit 205, and an output unit 206.

The input unit 201 acquires moving image data inputted from an external device, such as a digital moving image camera, and outputs the moving image data to the analysis unit 202 and further to the output unit 206. The moving image includes at least multiple still images (frames) and audio signals that synchronize in timing with the frames. The input unit 201 may acquire moving image data inputted from a moving image camera or other devices, covert the moving image data to digital moving image data, and then output the digital moving image data to the analysis unit 202 and further to the output unit 206. Note that the configuration may be changed so that digital moving image data is recorded on a recording medium, and the analysis unit 202 and the output unit 206 directly read the digital moving image data from the recording medium on which the moving image data has recorded. Furthermore, the moving image data may be subjected to processing, if necessary, such as a decryption process (scramble release process such as a B-CAS, for example), a decoding process (decoding process from an MPEG2, for example), a style conversion process (TS/PS, TS: Transport Stream, or PS: Program Stream, for example), a bit rate (compression rate) conversion process.

The analysis unit 202 analyzes the moving image data acquired from the input unit 201, and outputs the analysis result to the extraction unit 203 and further to the calculation unit 204. The analysis unit 202 detects subjects in the image. For example, the subjects include a face, the upper body of a person, a signboard, a building, a structure. The analysis unit 202 detects the subjects, and calculates the number of the subjects included in the moving image data, as an analysis result. The analysis unit 202 may calculate not only the number of the subjects but also reliability of the subject. In addition, the analysis unit 202 may evaluate sharpness of the subject. The reliability or the evaluation result may be simultaneously outputted as an evaluation scores (image evaluation scores) indicating the image quality of the partial image (or the moving image) in the subject.

The extraction unit 203 extracts an image, as a representative image, which is used when a summarized moving image is generated from the moving image data, by using the analysis result from the analysis unit 202. The representative image corresponds to a portion which the user may select as a summarized image. The details of an extraction process for the representative image will be described later. The extraction unit 203 outputs the extracted representative image to the calculation unit 204 and further to the output unit 206.

By using the analysis result by the analysis unit 202 and the representative image from the extraction unit 203, the calculation unit 204 analyzes partial moving images before and after and including the representative image, as an subject. Then, the calculation unit 204 calculates a change amount which means extent of change of the moving image. The calculation unit 204 outputs the calculated change amount to the determination unit 205. The details of a process by the calculation unit 204 will be described later.

By using the calculated change amount by the calculation unit 204, The determination unit 205 determines whether the partial moving images before and after and including the representative image are outputted after being divided or a still image as a representative image is outputted. The determination unit 205 outputs the determined result to the output unit 206. The determination unit 205 determines whether the moving image is outputted or the still image is outputted by comparing the change amount with a preset threshold. The following method is the simple, for example. Specifically, when the change amount exceeds the threshold, the outputted moving image is recorded as a moving image. On the other hand, when the change amount is equal to or smaller than the threshold, the outputted image is recorded as a still image. The process by the determination unit 205 will be described later in detail.

The output unit 206 associates the determination result acquired from the determination unit 205 with the representative image acquired from the extraction unit 203. The output unit 206 outputs the inputted moving image as still image data or moving image data, depending on the determination result. The following method is better as an output method. Specifically, the moving image data and the still image data may be written respectively. Or, a summarized moving image formed by connecting the moving image data and the still image data, may be outputted. Otherwise, images may be outputted by associating the inputted moving image data with information indicating a portion to be outputted as a moving image and a frame portion to be outputted as a still image, respectively. The outputted the moving image or the still image may be displayed on an image display apparatus. The image display apparatus is such as an LCD (a liquid crystal display) of a digital image camera, a personal computer, or a television. Or generating the summarized moving image may be displayed on the image display apparatus

As described above, according to the first embodiment, the signal processor 100 automatically extracts a representative image from only the moving images. The representative image is to be used summarized image. Then, the signal processor 100 automatically determines whether the representative image is recorded as a moving image or a still image. The embodiment has been briefly explained in the above, and next, operations of the respective components will be described more particularly.

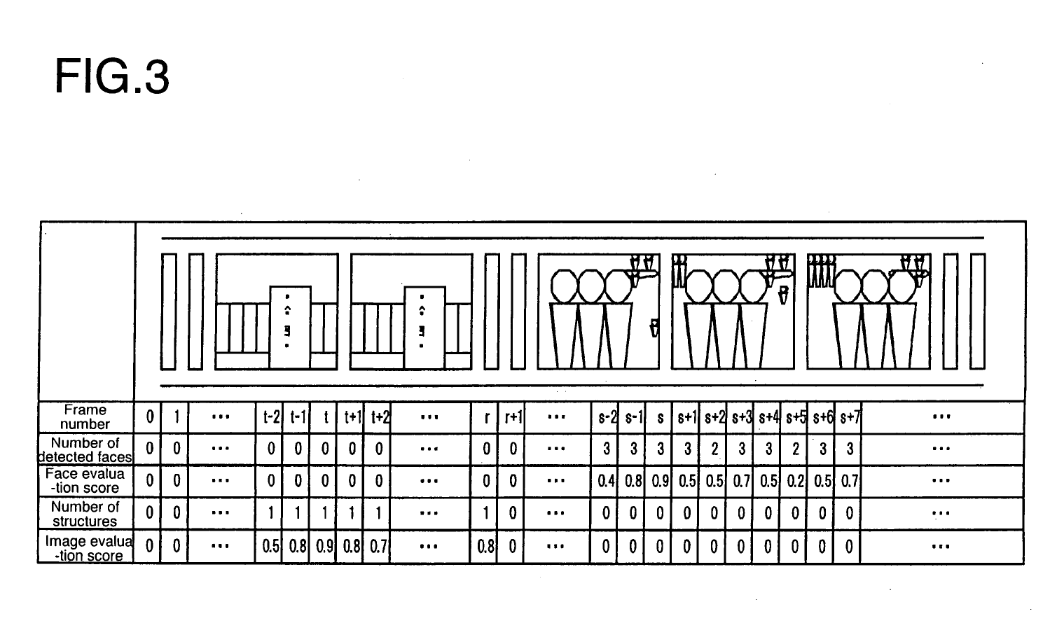

FIG. 3 shows an example of the analysis result outputted from the analysis unit 202. In FIG. 3, the number of detected faces (the number of detected faces), a face evaluation score indicating the reliability of the detected face (confidence measure as a face), the number of the detected structures as an subject excluding the face, such as buildings or signboards (the number of structures), and the reliability of the detected structure (confidence measure as a structure) are outputted for every still image frame. Each of the still image frames is acquired at the analysis unit 202 by decoding the moving image data.

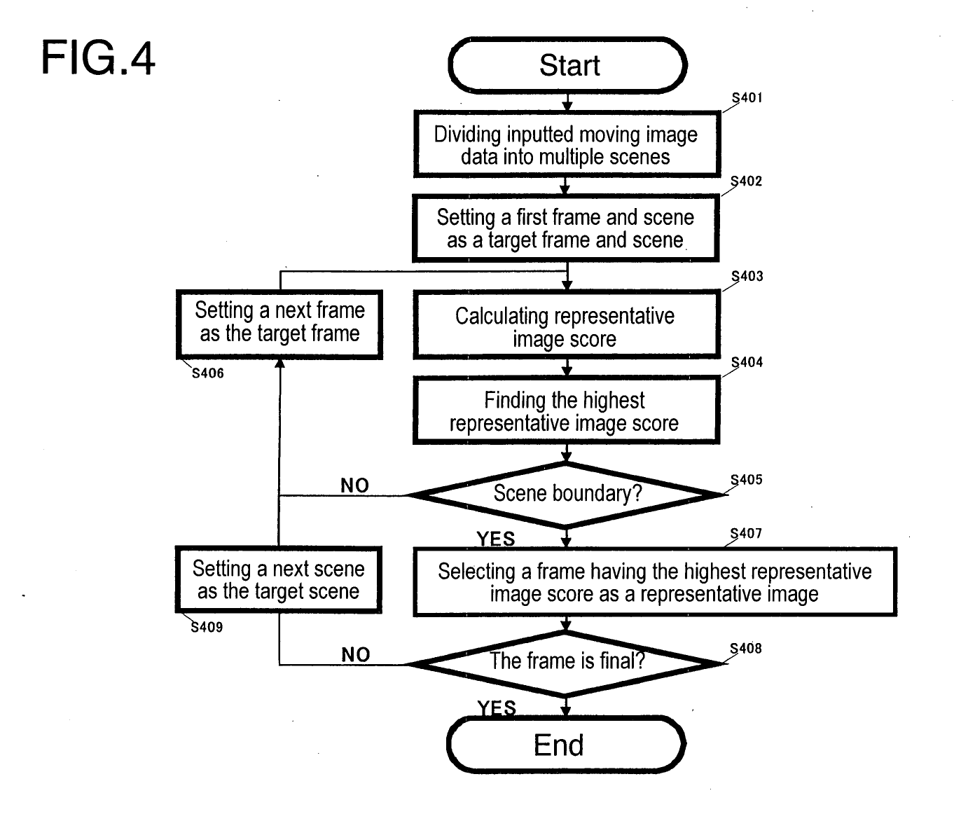

Next, the detailed operation of the extraction unit 203 in the case of inputting the analysis result as shown in FIG. 3 will be described with reference to a flowchart in FIG. 4. The extraction unit 203 firstly divides the inputted moving image data into multiple scenes (in the step S401). A scene defines a section of the moving image serving as a unit of detecting a representative image. Also, the scene is divided based on a predetermined section. For example, the inputted moving image may be divided every fixed time length. Or the inputted moving image may be divided based on a frame having a large difference of luminance histograms between adjacent frames. Further, the inputted moving image may be divided based on a frame corresponding to a timing when an audio signal starts to change largely. Moreover, the inputted moving image may be divided based on a frame corresponding to stopping or restarting the operation of photographing that is recorded separately. Any one of the methods can be used, or some methods can be combined to use. Here, an example of the result divided every fixed time length will be described. A scene boundary is detected between “r” and “r+1” with respect to an input signal. When the scene boundary is detected, a frame (the frame number is set to 0) and a scene which are first ones after the scene boundary are set as a target frame and a target scene respectively (in the step S402).

Subsequently, a representative image score of the target frame is calculated at the step S403. The representative image having a higher score is more important. According to the first embodiment, the representative image score is obtained in accordance with the following equation.

Representative image score=Σ{(the number of detected faces)×(face evaluation score)+(the number of structures)×(image evaluation score)}/3

In the first embodiment, when a long-time continuous moving image is summarized, a higher representative image score suggests that the image having the representative image score is more worth being included in the summarized moving image. Note that, the importance of a person, the size of a structure may be obtained and used to calculate the representative image score.

Here, in order to calculate the representative image score stably, an average value of the representative image scores of three frames including frames adjacent to the target frame is calculated as the representative image score of the target frame. For example, in FIG. 3, a face and a structure are neither detected in a first frame (frame number 0) nor the adjacent frame. Therefore, the representative image score of the first frame is 0.

Subsequently, the calculation results of the processed representative image scores are referred in the section of the target scene. The score having the highest value is set to a representative image score of the target scene at the step S404. Here, since the obtained result is the first one, a first value of 0 and the target frame number are recorded.

Subsequently, the signal processor determines whether or not a currently processed target frame is a scene boundary (in the step S405). If the processed frame is not the scene boundary, the target frame number is increased by one (in the step S406), and the same process is repeated.

For example, processing a target frame t and a target scene 0 is described in detail. Note that, the representative image score of the target scene is 0.73 in the process up to a target frame t−1. When a representative image score is calculated based on the analysis result of the target frame t and adjacent frames before and after the target frame t at the step S403, the representative image score is 0.83. Because the representative image score is higher than the representative image score of the already processed (past) frame, the representative image score of the target scene 0 is overwritten as 0.83, and the target frame t is recorded as a frame having a maximum evaluation score.

The same processes are repeated up to a frame r that is a scene boundary (in the step S405). A frame having the calculated maximum value of the representative image score in the section of the target scene is determined as a representative image at the step S407. For example, with respect to the target scene 0, because the frame t has the maximum score (value), the frame t is recorded as a representative image. Then, a next frame is processed. Subsequently, the signal processor 100 determines whether or not a currently processed target frame is a final frame (in the step S408). If the currently processed target frame is not the final frame, the representative image score is reset. Then, the target scene or the target frame is processed sequentially, and the same process is repeated until the final frame is processed. The moving image data shown in FIG. 3 is an example of the detected result in which frames t, s are detected as representative image points with respect to two scenes.

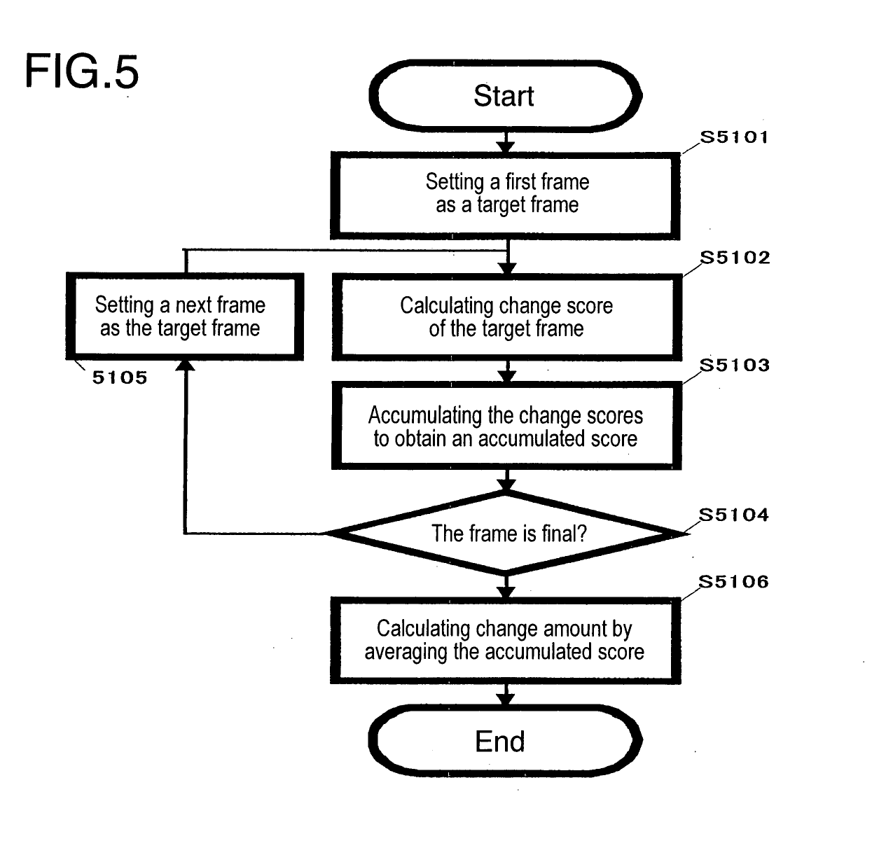

Next, the detailed operation of the calculation unit 204 will be described. FIG. 5 is a flow chart explaining the detailed operation of the calculation unit 204. The calculation unit 204 calculates a change amount between images. The change amount is used to determine whether the representative image is recorded as moving image data or still image data for each representative image detected by the extraction unit 203. For example, a case where the frame t and the frame s are detected as the representative images with respect to the moving image data shown in FIG. 3 will be described. Here, to simplify the explanation, a change amount is calculated from the representative image and four adjacent frames before and after the representative image on the time axis with the representative image centered on the time axis. To calculate the change amount, a predetermined period of time may be set, or the predetermined number of frames (or period of time) may be varied by using the representative score.

Firstly, a frame t−2 is set as a target frame at the step S5101. Next, a change score of the target frame is calculated at Step S5102. The change score is calculated by comparing the target frame with the adjacent frames before and after the target frame on the time axis, and indicates whether or not a change occurs. The change score having a higher value suggests a high possibility of being recorded as a moving image. Various methods of calculating the change score are conceivable. In the first embodiment, the change score is obtained in accordance with the following equation.

Change score=|(the number of detected faces and structures in the target frame)−(the number of detected faces and structures in next frame)|

A face is neither detected in the first frame t−2 nor the adjacent frames, while only one structure is detected in each of the first frame t−2 and the adjacent frames. Therefore a change score of the first frame t−2 is 0. Subsequently, a cumulative value of the change scores until the current process is calculated at the step S5103. Here, because the current process is performed as the first process, the change score is used as an accumulated score without any changes. Subsequently, the calculation unit 204 determines whether or not the currently processed target frame is a final frame in a search range (in the step S5104). If the currently processed target frame is not the final frame in the search range, the target frame number is increased by one (in the step S5105), and the same process is repeated. In order to simplify the explanation, a target frame t+2 is set as the final frame in the search range, and a change amount is obtained by averaging the accumulated score by the number of the frames that have been processed, at the step S5106. Note that, in the moving image data in which the representative image point t as an subject to be processed is set as the center, an subject to be detected is a person and the number of the subjects does not change. Therefore, the change amount is 0. Note that in the moving image data in which the representative image point s is set as the center, 0.2 is calculated as the change amount.

Next, the detailed operation of the determination unit 205 will be described. The determination unit 205 acquires the change amount from the calculation unit 204. The determination unit 205 compares the change amount with a threshold. The determination unit 205 determines that the representative image having the change amount higher than the threshold is outputted and recorded as moving image data. On the other hand, the representative image having the change amount less than the threshold is outputted and recorded as still image data. Here, when 0.2, for example, is set as the threshold. Since each of the representative image points t and s in the first embodiment has a value less than the threshold, the determination unit 205 determines that each of the representative images is recorded as a still image.

As described above, according to the first embodiment, even when moving image data is inputted, a section to be detected as a representative image is automatically determined. Furthermore, a determination is automatically made that a portion with a small change is recorded as still image data and a portion with a large change is recorded as moving image data, in accordance with the analysis result. Accordingly, the user does not have to designate a portion to be recorded as a representative image in advance. Meanwhile, when a recording format is determined based on the change amount of image characteristics, a section where only the background changes considerably may be recorded as a moving image. However, the signal processor 100 according to the first embodiment adopts changes of a subject (such as a structure or a person). This enables switching to an appropriate one of a moving image and a still image depending on the contents. For example, if a focused subject does not change, the subject is recorded as a still image.

### Description of the Second Embodiment

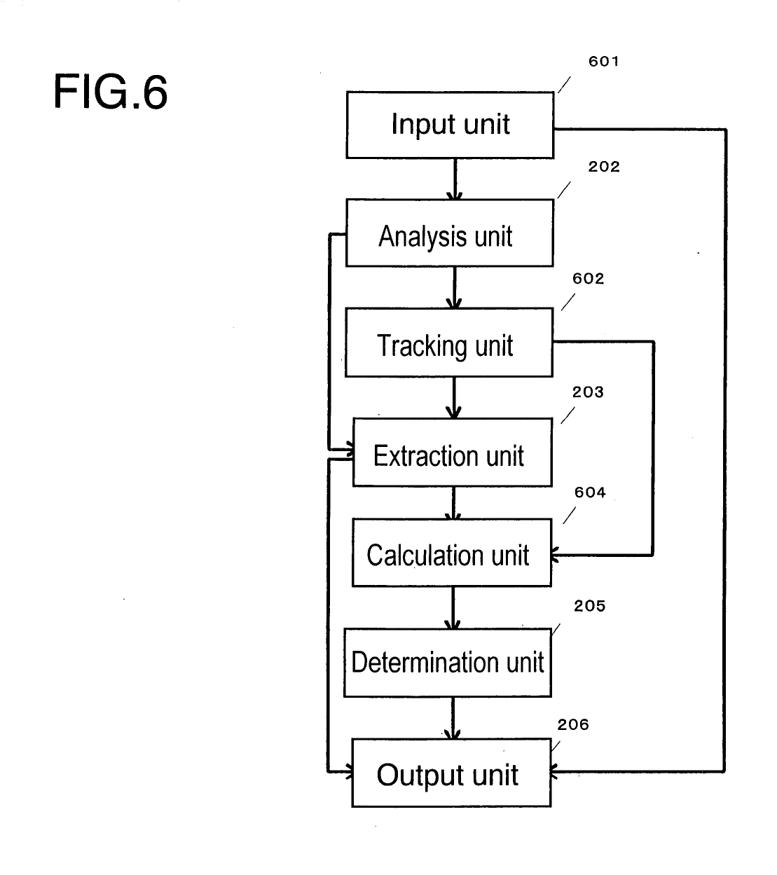

FIG. 6 is a block diagram showing functional elements in the signal processor according to a second embodiment. Note that, the same reference numbers are given to the same configuration as the first embodiment described above, and the description will be omitted. The signal processor according to the second embodiment includes the input unit 201, the analysis unit 202, the extraction unit 203, a calculation unit 604, the determination unit 205, the output unit 206, and a tracking unit 602. The second embodiment is different from the first embodiment in the configuration of the tracking unit 602. The tracking unit 602 calculates a movement amount of the subject detected by the analysis unit 202 (hereinafter, referred to as “subject” in the second embodiment) in the moving image data. The second embodiment is different from the first embodiment in that the movement amount of the subject is used to determine whether or not a representative image is recorded as moving image data or still image data.

The analysis unit 202 analyzes the moving image data acquired from the input unit 201. Then, the analysis unit 202 outputs the analysis result to the extraction unit 203, the tracking unit 602, and the calculation unit 604. For example, the analysis unit 202 detects subjects including a face of a person, the upper body of a person, a signboard, a building, and a structure. Then, the analysis unit 202 outputs a frame corresponding to the number of the subjects included in the moving image data, as an analysis result. The analysis unit 202 not only detects the subjects but also evaluates whether or not the face or the structure is clearly photographed. The analysis unit 202 may simultaneously output an evaluation score indicating an image quality of a portion of the subjects.

The tracking unit 602 tracks a correspondence relationship of the subject detected by the analysis unit 202 in the adjacent frames before and after the frame on the time axis. When a subject corresponding to the subject in the frame is present in the frames adjacent to the frame (hereinafter, referred to as “adjacent frames”), the tracking unit 602 calculates a movement amount between the frames, and outputs the movement amount to the calculation unit 604. It is preferable to use a method of tracking the subject by combining the following two methods. One is a method in which, when regions of the subjects of the same kind are overlapped with each other in the adjacent frames, it is determined that the subjects corresponding to each other are the same. The other is a method in which face clustering is performed on the detected face so that the face classified in the same classification (class) is determined as the same person and then is traced. The former method is a general method without depending on the kinds of the subjects. However, tracking is difficult when multiple subjects exist and one subject is hidden behind the other subjects. On the other hand, the latter method is capable of highly accurate classification when a face can be detected correctly. However, tracking is difficult when a face is difficult to be detected (For example, the face is turned to the back). Either of the methods may be used by considering a storage capacity of the processor, a process speed, a load on the controller.

The calculation unit 604 analyzes partial moving images before and after and including the representative image by using the analysis result inputted from the analysis unit 202 and the tracking unit 602, and the representative image calculated by the extraction unit 203. Then, the calculation unit 604 calculates the change amount and outputs the change amount to the determination unit 205. The second embodiment is different from the first embodiment in that the movement amount of the subject calculated by the tracking unit 602 is utilized. By using the change amount acquired from the calculation unit 604, the determination unit 205 determines whether the representative image is recorded as a moving image or a still image. The determination unit 205 outputs the determined result to the output unit 206. The determination unit 205 also determines whether the representative image is recorded as the moving image or the still image by comparing a preset threshold value with the change amount. The representative image is outputted as the moving image when the change amount exceeds the threshold value. On the other hand, the representative image is outputted as the still image when the change amount is equal to or smaller than the threshold value is inputted. Note that concerning an output format, the moving image is associated with the frame corresponding to the moving image or the partial moving image, and then only a table including the recording format is outputted, or the frame or the moving image may be recorded in the memory, in the same manner as those in the first embodiment.

As described above, according to the second embodiment, the operation is performed in that the following manner. A material including only moving images is inputted, an image that is worth being let as a summarized moving image is automatically detected as a representative image, and a determination is automatically made as to whether the representative image is recorded as a moving image or a still image according to the movement amount of the subject.

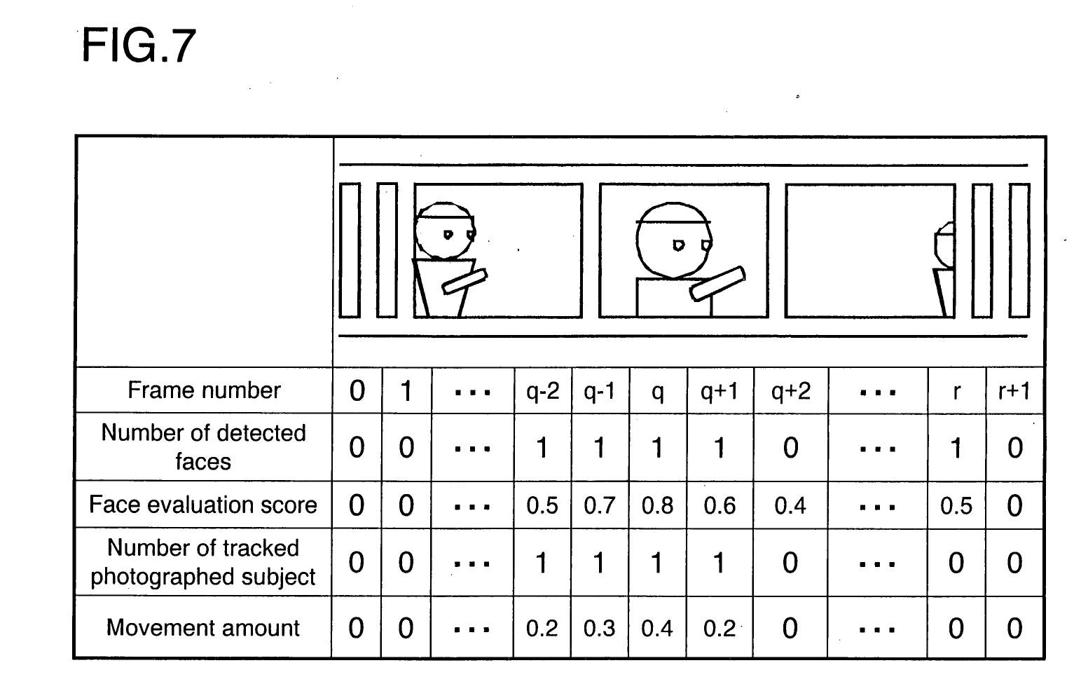

Hereinafter, operations of each component will be described. FIG. 7 shows an example of the analysis result obtained by the analysis unit 202 and the tracking unit 602. The number of the detected faces, a face evaluation score indicating the reliability of the detected face acquired by the analysis unit 202, the face of the subject tracked by the tracking unit 602, and the movement amount of the subject in the screen, are outputted for each still image frame acquired by decoding the moving image data.

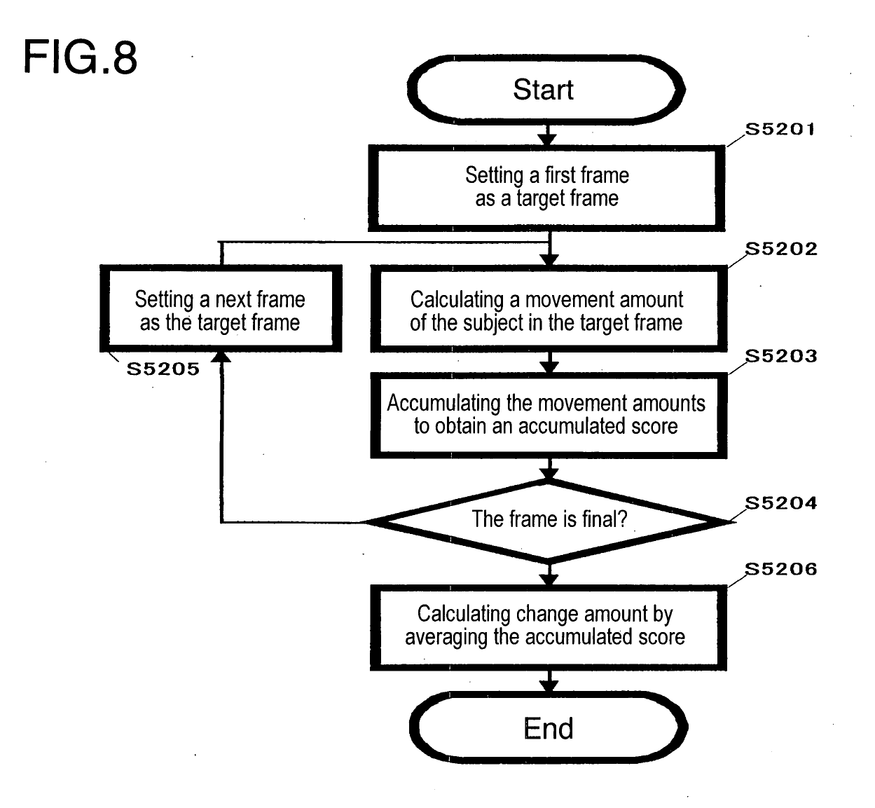

Next, the detailed operation of the calculation unit 604 will be described. FIG. 8 is a flow chart explaining operation of the calculation unit 604. The calculation unit 604 calculates a change amount for each representative image extracted by the extraction unit 203. The change amount is used to determine whether the representative image is outputted as moving image data or still image data. In the second embodiment, a case where a frame q is extracted as a representative image by taking the moving image data shown in FIG. 7 as an example. In order to simplify the explanation, the calculation unit 604 calculates the change amount from five adjacent frames including the representative image set as the center, in the example.

The calculation unit 604 sets a frame q−2 as a target frame at the step S5201. Then, the calculation unit 604 subsequently calculates a subject movement amount of the target frame at the step S5202. The subject movement amount indicates whether or not a position of the subject changes as a result of comparison of the target frame with the adjacent frames. The subject movement amount having a higher value means a high possibility of being recorded as a moving image. Various methods of calculating a score are conceivable. According to the second embodiment, the subject movement amount is obtained in accordance with the following equation.

Subject movement amount=|movement amount of subject detected in the target frame|

When one face is detected in the first frame q−2 as a subject and the movement amount of the first frame q−2 is 0.2, the subject movement amount is 0.2. Subsequently, a cumulative value of the processed subject movement amounts is calculated at the step S5203. Here, because the current process is performed as the first process, the subject movement amount is used as the accumulated score without any changes. Subsequently, the calculation unit 604 determines whether or not a target frame currently processed is a final frame in the moving image (in the step S5204). If the target frame is not the final frame, the target frame number is increased by one (in the step S5205), and the same process is repeated. In the example of FIG. 7, a target frame q+2 is set as the final frame in the search range, and a change amount is obtained by averaging the accumulated score by the number of the frames that have been processed at the step S5206. In the second embodiment, the change amount means average of the subject movement amount between two adjacent frames. For example, the change amount is 1.1/5=0.22 in the moving image data in which a representative image point q as a subject to be processed is set as the center. Next, the operation of the determination unit 205 will be described. The determination unit 205 compares the change amount acquired from the calculation unit 604 with a threshold. If the determination unit 205 determines that the change amount of the representative image is larger than the threshold, the determination unit 205 outputs the representative image as moving image data. On the other hand, if the determination unit 205 determines that the change amount of the representative image is less than the threshold, the determination unit 205 outputs the representative image as still image data. Here, when 0.2 is set as the threshold, the representative image q in FIG. 7 is determined as to be recorded as a moving image.

As described above, according to the second embodiment, even when long-time continuous moving image data is inputted, the signal processor automatically determines a section to be detected as a representative image. Moreover, the signal processor automatically determines that a portion with a small change is recorded as still image data and a portion with a large change is recorded as moving image data, in accordance with the analysis result of the subject. In particular, even when the number of the subjects has no change in the moving image, the moving image is recorded as a still image if a same subject does not move greatly in the screen. On the other hand, the moving image is recorded as moving image data if the same subject moves greatly. Accordingly, moving image and still image can be switched to suits a summarized moving image according to the contents of the subject.

### Description of the Third Embodiment

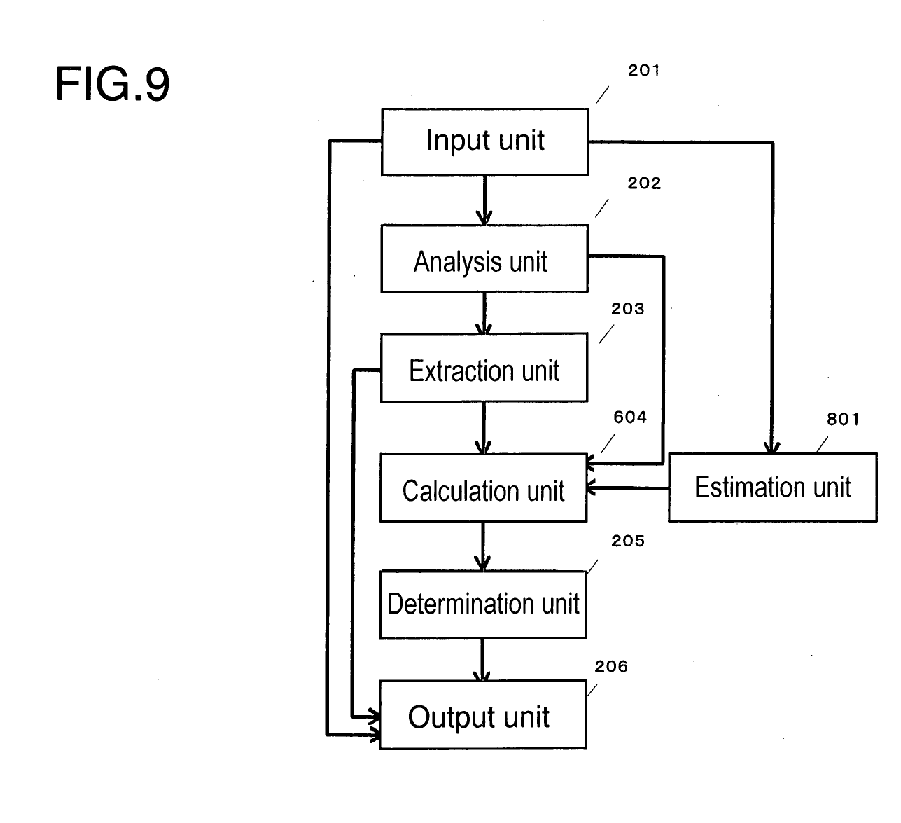

FIG. 9 is a block diagram showing functional elements in the signal processor according to a third embodiment. The signal processor includes the input unit 201, the analysis unit 202, the extraction unit 203, the calculation unit 604, the determination unit 205, the output unit 206, and an estimation unit 801. The third embodiment is different from the first embodiment and the second embodiment in that the estimation unit 801 to estimate a sound source is added. More particularly, in the third embodiment, sound data corresponding to the moving image data acquired from the input unit 201 is analyzed to know whether or not a special sound source is played on the background. The special sound source is one having a possibility of being recorded as a moving image. Then, the signal processor determines whether a representative image is outputted as moving image data or still image data in accordance with the kind of the sound source. Note that, the same reference numerals are given to the same configurations as the first embodiment and the second embodiment described above, and the description will be omitted.

The input unit 201 acquires moving image data inputted from an external digital moving image camera, a reception tuner for digital broadcast, and other digital devices. The input unit. 201 outputs the moving image data to the analysis unit 202 and further to the output unit 206. The input unit 201 also acquires sound data corresponding to the moving image data and outputs the sound data to the estimation unit 801.

The estimation unit 801 analyzes the sound data, and estimates a sound source that has played at each time corresponding to the image frame. The estimation unit 801 classifies the inputted sound into sound sources defined in advance. The sound sources may include a speech, music, a noise, clapping of hands, a cheer, silence, for example. When the estimation unit 801 detects a desired sound source, the estimation unit 801 scores to a high score in order to show a possibility that the moving image data is worth being recorded as a moving image. For example, the estimation unit 801 may classify the sound sources by a method in that learning statistical model such as a Gaussian Mixture Model for each kind of the sound sources, and adopting the kind of the sound sources with the maximum posterior probability of the similarity with the model as a determination result. In this example, when the inputted sound is classified into the clapping of hands, the cheer, or the sound, the signal processor determines that a sound source as a subject is detected. Then, the estimation unit 801 adopts the posterior probabilities with respect to the clapping of hands, the cheer, or the sound source as a sound source evaluation score.

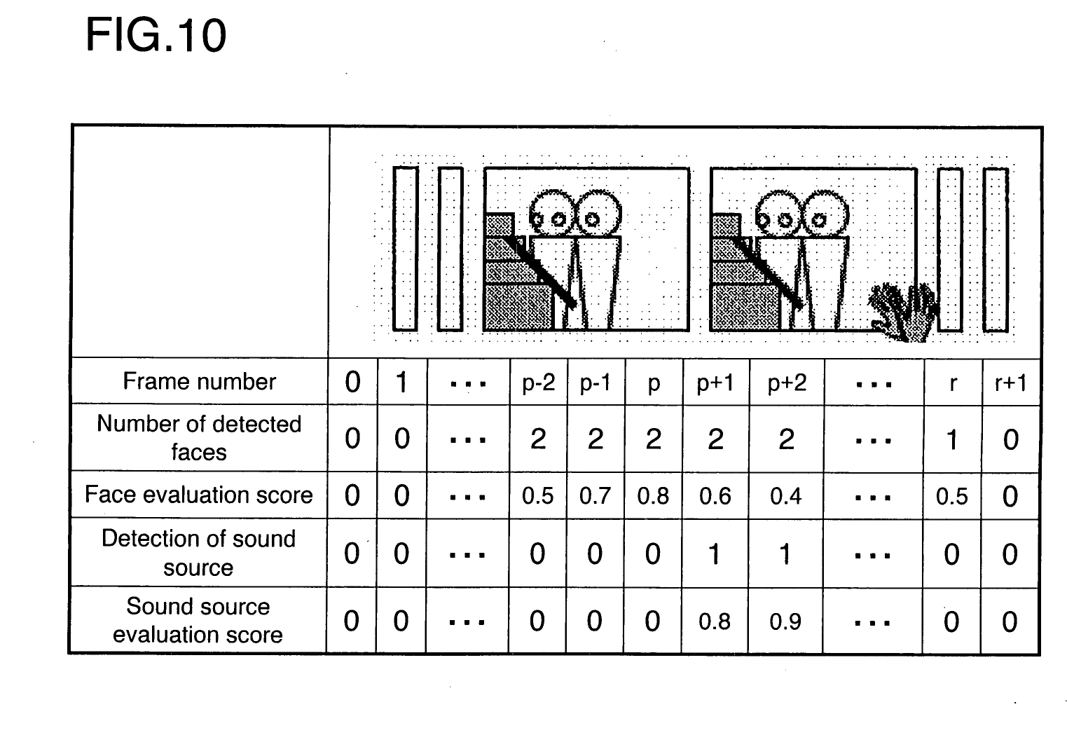

The calculation unit 604 calculates a change amount of the representative image by using the analysis results (sound source evaluation score) acquired from the analysis unit 202 and the estimation unit 801, and by using the representative image acquired from the extraction unit 203. Then, the calculation unit 604 outputs the calculated change amount to the determination unit 205. The third embodiment is different from the first embodiment and the second embodiment in that the sound source evaluation score acquired from the estimation unit 801 is adopted. By using the change amount acquired from the calculation unit 604, the determination unit 205 determines whether the representative image is recorded as a moving image or a still image, by using the following method. Then, the determination unit 205 outputs the determined result to the output unit 206. Specifically, the determination unit 205 compares the change amount and a threshold. If the change amount is larger than the threshold, the representative image is outputted as the moving image. On the other hand, if the change amount is equal to or smaller than the threshold, the representative image is outputted as the still image. Next, operations of each component will be described below. FIG. 10 shows an example of the analysis results inputted from the analysis unit 202 and the estimation unit 801. The number of detected faces and a face evaluation score are outputted by the analysis unit 202 for each still image frame. The face evaluation score indicates the reliability of the detected face. In addition, detection of the sound source and the sound source evaluation score are outputted by the estimation unit 801. The detection of the sound source indicates whether or not a sound source having a high possibility to be recorded as a moving image is detected. The sound source evaluation score indicates likelihood of the sound source.

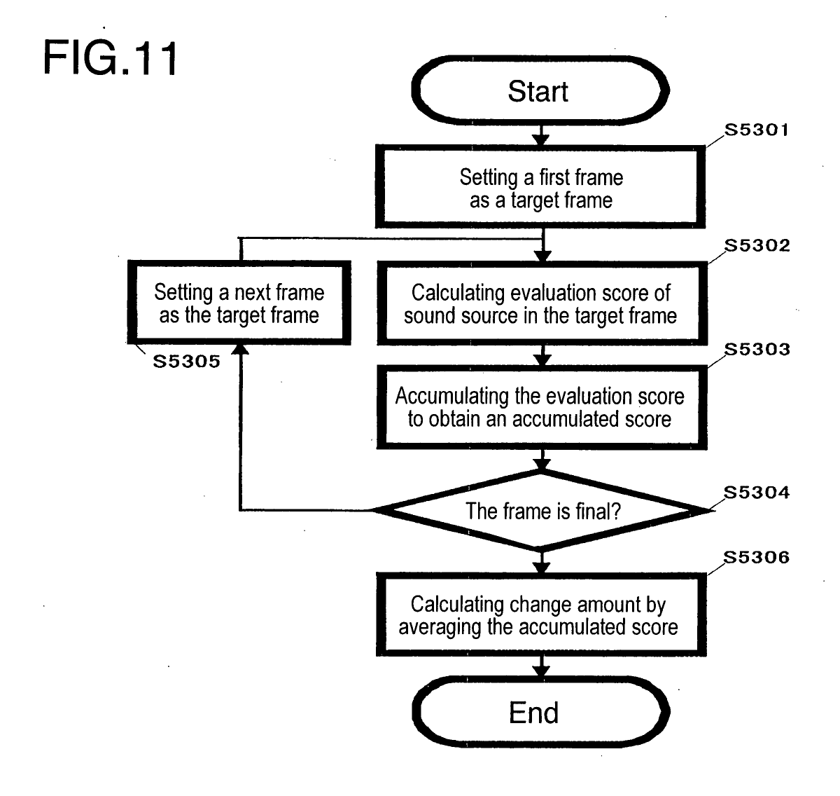

The detailed operation of the calculation unit 604 will be described. FIG. 11 is a flowchart explaining the operation of the calculation unit 604. The calculation unit 604 calculates a change amount for each representative image extracted by the extraction unit 203. The change amount is used to determine whether the representative image is outputted as moving image data or still image data. An example case that a frame p is extracted as a representative image by taking the moving image data shown in FIG. 10. In order to simplify the explanation, in this example, the change amount is calculated from five adjacent frames including the representative image set as the center.

A frame p−2 is set as a target frame at the step S5301 by the calculation unit 604. Subsequently, a sound source evaluation score of the target frame is calculated at the step S5302. The sound source evaluation score indicates whether a sound source worth being recorded as a moving image is played in the target frame. The sound source having a higher value means a higher possibility of being recorded as a moving image. Various methods of calculating a score are conceivable. According to the third embodiment, the sound source evaluation score is obtained in accordance with the following equation.

Sound source evaluation score=|sound source evaluation score detected in the target frame|

In the example of FIG. 10, a sound source is not detected in a first frame p−2. Therefore a sound source evaluation score is 0. Subsequently, a cumulative value of the sound source evaluation scores is calculated at the step S5303. Here, because the current process is performed as the first process, the sound source evaluation score is used as the accumulated score without any changes. Subsequently, the calculation unit 604 determines whether a target frame currently processed is a final frame in the moving image to be processed (in the step S5304). If the target frame is not the final frame, the target frame number is increased by one (Step S5305), and the same process is repeated. In this case, a target frame p+2 is set as the final frame in the search range, and a change amount is obtained by averaging of the accumulated score by the number of the frames that have been processed at the step S5306. In the third embodiment, the change amount means change of sound source between two adjacent frames. For example, the change amount is 1.7/5=0.34 in the moving image data in which a representative image point p as a subject to be processed is set as the center.

The detailed operation of the determination unit 205 will be described. The determination unit 205 compares the change amount acquired from the calculation unit 604 with a threshold. If the change amount of the representative image is larger than the threshold, the determination unit 205 determines that the representative image is outputted and recorded as moving image data. On the other hand, if the change amount of the representative image is less than the threshold, the determination unit 205 determines that the representative image is outputted and recorded as still image data. Here, when 0.2 is set as the threshold, the representative image point p in FIG. 9 is determined as to be recorded as a moving image.

As described above, according to the third embodiment, even when long-time continuous moving image data is inputted, the signal processing automatically detects a section to be a representative image. In addition, the signal processing automatically determines that a portion with a small change is recorded as still image data, and a portion with a large change is recorded as moving image data, in accordance with the analysis result of the subject. In particular, as described in the third embodiment, the operation is performed in such a manner that the moving image with a small change is recorded as moving image data if the sound source worth being recorded as a moving image is played on the background. This makes it possible to switch between a moving image and a still image more appropriately depending on the contents of the subject.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and spirit of the inventions.

What is claimed is:

1. A signal processor comprising:
an input unit to receive a moving image including a plurality of images;
an extraction unit to analyze the moving image and to extract a representative image from the moving image;
a calculation unit to calculate a change amount of a partial moving image including the representative image, the change amount indicating degree of change;
a determination unit, using the change amount, to judge which the representative image or at least a part of the moving image is outputted; and
an output unit to output the representative image or the partial moving image according to a corresponding output format.

2. The signal processor of claim 1, wherein
the extraction unit further includes an analysis unit to detect an subject appearing in the moving image, and
the extraction unit calculates an evaluation score for each image based on an appearance frequency of the subject, and selects an image having the highest evaluation score among images, as the representative image.

3. The signal processor of claim 1, further comprising a determination unit to analyze an audio signal corresponding to the partial moving image and to determine a kind of a sound source of the audio signal, wherein
the calculation unit calculates the change amount based on the kind of the sound source.

4. The signal processor of claim 2, further comprising a tracking unit to track the subject, wherein the calculation unit calculates the change amount based on a movement amount of the tracked subject.

5. The signal processor of claim 2, further comprising a measurement unit to measure the total number of the subjects, wherein the calculation unit calculates the change amount based on the total number of the subjects.

6. The signal processor of claim 1, further comprising a memory to store any one of the representative image or the partial moving image, which is judged in the determination unit.

7. The signal processor of claim 1, wherein the determination unit to compare the change amount with a threshold and thereby to judge which the representative image or at least a part of the moving image is outputted.

8. The signal processor of claim 1, further comprising a display unit to display the representative image or the partial moving image; which is judged in the determination unit.
